(19) United States
(12) Patent Application Publication
(10) Pub. No.: US 2017/0214024 A1
(43) Pub. Date: Jul. 27, 2017

(54) SELF-ASSEMBLY OF MULTIPLE INTERCONNECTED TERMINALS

(71) Applicants: Donald Panoz, Braselton, GA (US); James Rhett Mayor, Braselton, GA (US); Dale Lovell, Alpharetta, GA (US)

(72) Inventors: Donald Panoz, Braselton, GA (US); James Rhett Mayor, Braselton, GA (US); Dale Lovell, Alpharetta, GA (US)

(21) Appl. No.: 15/411,026

(22) Filed: Jan. 20, 2017

Related U.S. Application Data
(60) Provisional application No. 62/286,036, filed on Jan. 22, 2016.

(51) Int. Cl. H01M 2/20; H01R 13/639; H01R 25/16

(52) U.S. Cl. CPC H01M 2/206; H01R 25/162; H01R 13/639; H01M 2220/10

(57) ABSTRACT

According to various aspects, exemplary embodiments are provided of an interconnection device coupled to one or more terminals of one or more batteries that enables the charging and discharging of the one or more batteries. The interconnection device includes an insulating material, a conductor coupled to the insulating material, the conductor is shaped in a pattern to facilitate one or more interconnections with the batteries when the interconnection device is coupled to the one or more terminals of the one or more batteries. Other embodiments described herein disclose a method of manufacturing a device for the interconnection of one or more electrical terminals wherein the method includes a single-action assembly of the device onto one or more batteries.

### RELATED APPLICATION DATA

This application claims priority from U.S. Provisional Patent Application No. 62/286,036, which was filed on Jan. 22, 2016, which application is hereby incorporated herein by reference in its entirety.

### BACKGROUND

A battery pack typically is a plurality of batteries interconnected in series, parallel, or a combination thereof to deliver power. These battery packs can be used as power sources in a wide-range of applications from electric motors, stand-alone power supplies, uninterrupted power supplies and battery backups. Individual batteries in battery packs are interconnected typically through the use of cables, the ends of which are connected to terminals of individual batteries. Use of cables as interconnectors, however, offer disadvantages in that they add weight, reduce efficiency, and from a manufacturing perspective involve multiple assembly actions that can lead to cables being incorrectly connected.

Another way batteries in packs can be interconnected is through the use of standard printed circuit boards (PCBs), where the terminals of individual batteries are connected to traces of a conductor, such as copper, in a standard PCB. Standard PCBs also offer disadvantages. Standard PCBs do not provide for integral cooling of the conductor. As a result, use of a standard PCB limits the amount of current that can be pushed through the conductor without substantially increasing the surface area of the conductor. This constraint leads to PCBs with large surface areas that are required to provide the ambient cooling.

Furthermore, to increase the amount of current that can flow through a conductor in a standard PCB, multiple layers are used to increase the thickness of the conductor. This results in an increase in manufacturing time and such multilayer standard PCBs are thermally limited, such that the conductor in individual layers on the standard PCB can heat to temperatures that may cause delamination failures. Additionally, multiple-action assembly is required to make all of the interconnections between the batteries and the conductor in the standard PCB.

### SUMMARY

According to various aspects, exemplary embodiments are provided of interconnection devices of one or more electrical terminals that enables the charging and discharging of batteries. In an exemplary embodiment, an interconnection device coupled to one or more terminals of one or more batteries that enables the charging and discharging of the one or more batteries including an insulating material, a conductor, where the conductor is shaped in a pattern to facilitate one or more interconnections with the batteries when the interconnection device is coupled to the one or more terminals of the one or more batteries.

According to another embodiment, a power source having an interconnection device, the interconnection device includes an insulating material, a conductor coupled to the insulating material, one or more batteries, each battery having one or more terminals, where the interconnection device is coupled to the one or more batteries, and wherein the conductor is shaped in a pattern to facilitate one or more interconnections with the one or more batteries with the device using a cooling system, such as a conformal cooling system, in a manner that improves efficiency, reduces weight, and extends battery life.

According to another embodiment, a method of manufacturing a power source having an interconnection device and one or more batteries each having one or more terminals, the method including, interconnecting the one or more terminals of the one or more batteries by a single-action assembly of the device onto the one or more terminals of the one or more batteries.

### DESCRIPTION OF THE DRAWINGS

FIG. 1 is a perspective view of an interconnection device

FIG. 2 is another perspective view of an interconnection device.

FIG. 3 is a cross-sectional view of an interconnection device.

FIG. 4 is another perspective view of an interconnection device.

FIG. 5 is another perspective view of an interconnection device.

FIG. 6 is another perspective view of an interconnection device.

FIG. 7 is another perspective view of an interconnection device.

### DETAILED DESCRIPTION

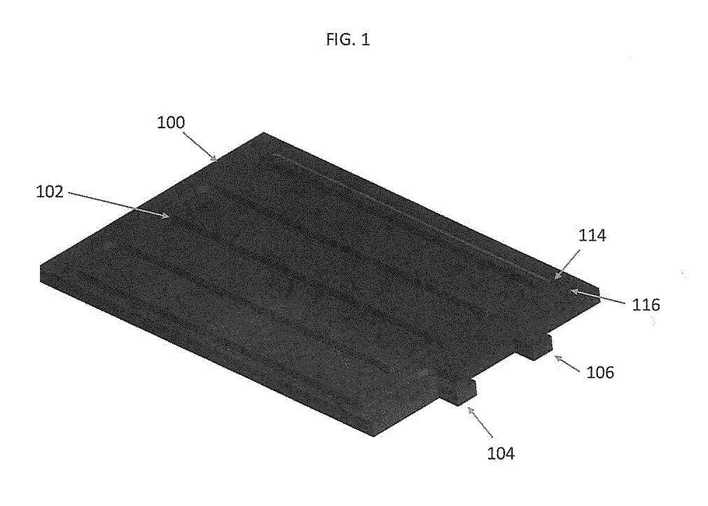

FIG. 1 is a perspective view of an interconnection device 100. The interconnection device is preferably made out of an insulating material, which may or may not be laminated, and includes a channel 102 in which a conductor (not shown) is placed. In the embodiment of FIG. 1, the channel visible to the reader is a conformal channel and on the reverse face of the device 100 is the opposing or negative channel. The device 100 also includes a first terminal 104 and a second terminal 106. Also shown in FIG. 1 is an inlet 114 and an outlet 116, which are features of a conformal cooling system. In this system, a cooling medium enters the inlet 114 and flows in the channel 102, preferably surrounding the conductor, and exits the device through the outlet 116.

The interconnection device 100 can be made of any insulating material including polycarbonate, polyvinyl chloride, Nomex, Mylar, and Kapton.

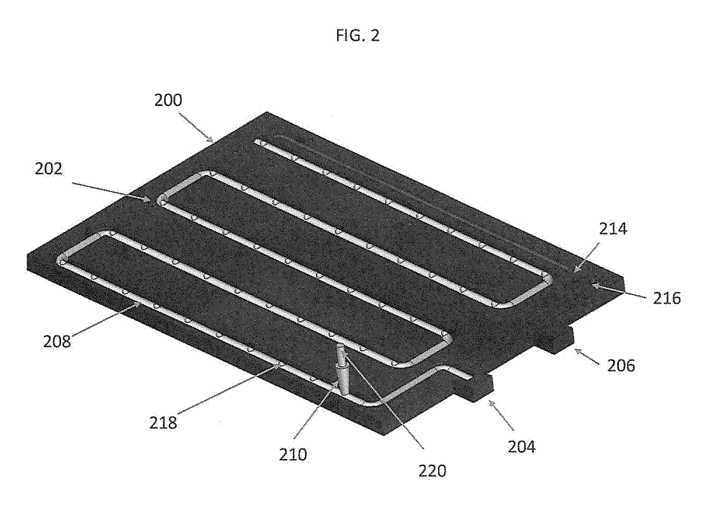

FIG. 2 is a perspective view of an interconnection device 200 according to another embodiment. The interconnection device 200 includes a channel 202, a first terminal 204, a second terminal 206, and a conductor 208. The conductor 208 conforms to the channel 202 and is placed in the channel 202. The conductor 208 may be held in the channel or maybe put in place by clamps or cable clamps. The channel 202 is shaped in a pattern to facilitate interconnections with the batteries such that the batteries can be connected in series, parallel, series-parallel, and/or individually, as well as any combinations thereof

The conductor 208 preferably includes a plurality of predrilled openings of a shape such as a conical opening 218. The openings in the conductor 208 allow for mating of a plurality of pins, one of which, pin 210 is shown in FIG. 2. The pins connect the device 200 to the terminals of the batteries (not shown). The terminal end 220 of the pin 210 illustrates the portion of the pin 210 that connects with the terminal of a battery. For each of the openings in the conductor 208 shown in FIG. 2 there is a corresponding pin, such as pin 210, which will be shown in subsequent figures.

The conductor 208 can be any electrical conductor such as copper, gold, platinum, aluminum, carbon fiber, or engineered materials like platinum-doped nanotubes.

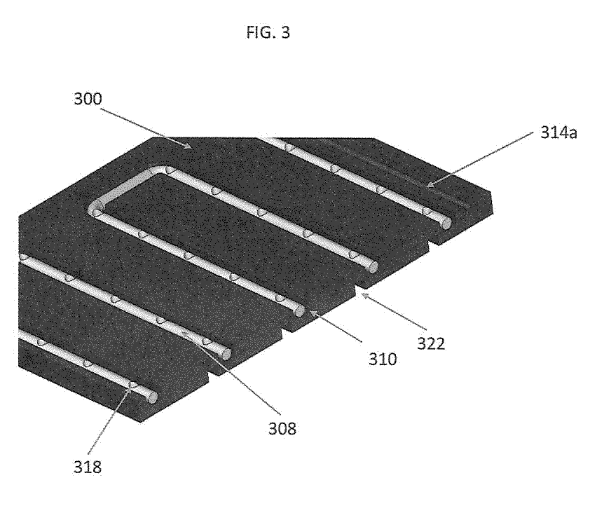

FIG. 3 is a cross-sectional view of an interconnection device 300. FIG. 3 illustrates a channel 302, in which a conductor 308 is placed. The conductor 308 includes drilled openings 318. FIG. 3 also illustrates a negative channel 322 and a portion 314a of an inlet where a cooling medium can be introduced into the channel 302. In an exemplary cooling system, the cooling medium enters through the inlet and enters the channel 302. The cooling system conforms to the channel in that it flows through the channel around the conductor. The cooling medium could be any fluid including a gas to cool the conductor 308. Cooling mediums can include water, glycol, nitrogen gas, liquid nitrogen, air, silicon oil, and engineered fluids.

As shown in FIG. 3, the cross-sectional area of the conductor is smaller than the cross-sectional area of the channel. Thus, there is a region around the conductor where the cooling medium will flow in the channel 302. By conforming to the channel 302 and surrounding the conductor 308, the cooling medium can cool the conductor 308, thereby allowing high current to flow through the conductor 308. While the cross-sectional area of the conductor 308 in FIG. 3 is circular, it could also be in any shape such as rectangular or in the shape of star, provided that the cross-sectional area is smaller than that of the channel so that the cooling medium can flow in the channel. Alternatively, the cooling system could include a hollow tube of some cross section, similar to the cross section of the channel, where the cooling fluid is pushed through the internal passage. The channels 302 and 322 while shown as rectangular could also be any shape such as circular or ovular. In an exemplary cooling system, the heat load can be rejected through a radiator that may be integral to the device.

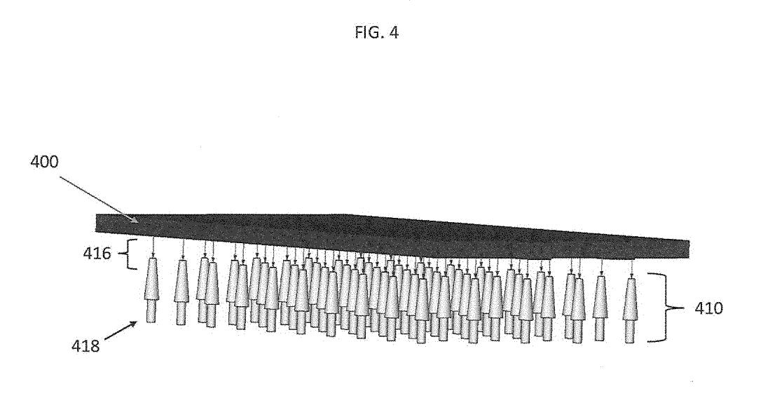

FIG. 4 is another embodiment of an interconnection device 400. The device 400 is positioned above pins 410. Each of the pins are attached to terminals of batteries (not shown). Element 418 illustrates one of these ends. During assembly, the device is pressed on to the pins 410, such that the top of the pins mate with holes in the conductor (not shown), as illustrated for example in previous figures. This is a single-action assembly whereby the device 400 is connected to the batteries via the pins 410. And as a result of this single-action, the batteries are interconnected as designed, whether in series, parallel, or a combination thereof. Arrows 416 illustrate the direction of the single-action assembly where the device 400 is pressed onto the pins 410. In an alternative, the pins 410 can be spring loaded for uniform contact pressure between the conductor and the pins.

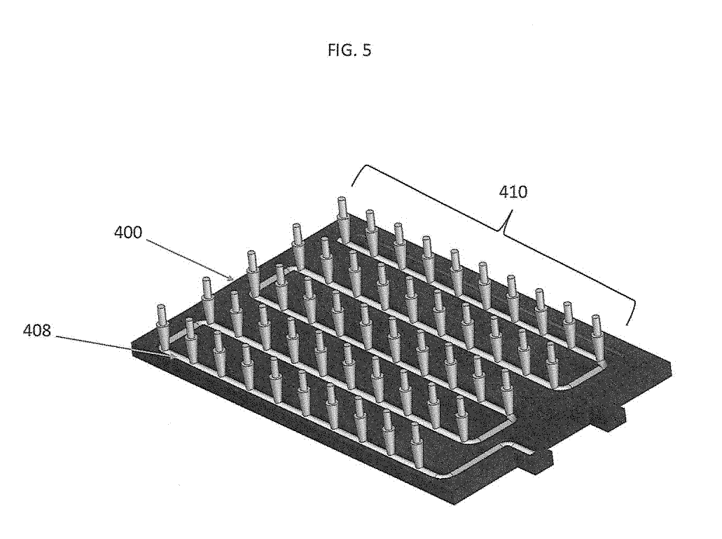

FIG. 5 illustrates a perspective view of the device 400 that shows the device 400 pressed onto the pins 410, with the tops of the pins 410 being mated to the conductor via the holes in the conductor 408.

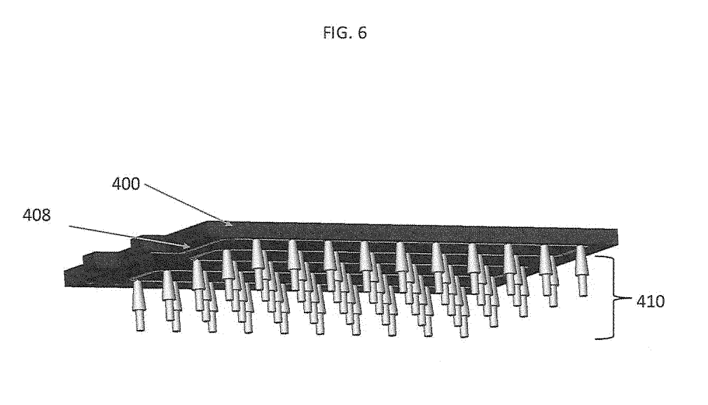

FIG. 6 is another perspective view of the device 400 with the pins 410 mated to the conductor 408.

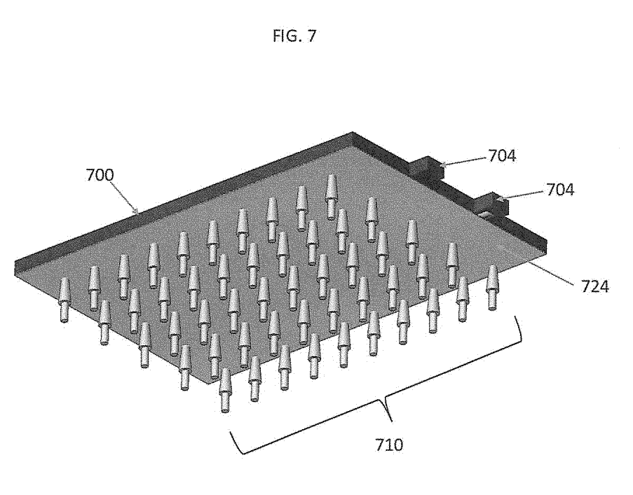

FIG. 7 illustrates a perspective view of an interconnection device 700 having a first terminal 704 and a second terminal 706. The device 700 is pressed onto a plurality of pins 710. FIG. 7 illustrates an insulation surface 724 through which the pins 710 penetrate when the device 700 is pressed on the pins 710. The insulation surface 724 seals the device 700 so that the cooling system, as described above, does not leak. In the previous figures, the insulation surface was removed for clarity so that features of the device could be described.

The interconnection devices described herein can also include clamps or snaps or other locking means. During the single-action assembly, the device is pressed onto the pins, and the snaps, clamps or other locking means are used to mate the device onto a frame of a battery bank. Furthermore, the interconnection devices described herein can also be layered on top of one another to form a multi-layer system of interconnection devices.

While embodiments have been illustrated and described herein, it is appreciated that various substitutions and changes in the described embodiments may be made by those skilled in the art without departing from the spirit of this disclosure. The embodiments described herein are for illustration and not intended to limit the scope of this disclosure.

1. An interconnection device coupled to one or more terminals of one or more batteries that enables the charging and discharging of the one or more batteries comprising:
an insulating material,
a conductor coupled to the insulating material,
wherein the conductor is shaped in a pattern to facilitate one or more interconnections with the batteries when the interconnection device is coupled to the one or more terminals of the one or more batteries.

2. The interconnection device of claim 1, wherein the insulating material further comprises a channel, wherein the conductor is disposed in the channel.

3. The interconnection device of claim 2, wherein the insulating material includes an inlet and an outlet, the inlet and outlet coupled to the channel, wherein the inlet receives a coolant that flows through the channel and exits through the outlet, thereby cooling the conductor.

4. The interconnection device of claim 3, wherein the coolant is selected from the group consisting of water, glycol, nitrogen gas, liquid nitrogen, air, silicon oil, and engineered fluids.

5. The interconnection device of claim 1 wherein the conductor further comprises openings that correspond to the one or more terminals of the one or more batteries.

6. The interconnection device of claim 1 where in the insulating material is laminated.

7. The interconnection device of claim 1 wherein the conductor is selected from the group consisting of copper, gold, platinum, aluminum, carbon fiber or platinum-doped nanotubes.

8. The interconnection device of claim 1 wherein one or more interconnections include a series connection.

9. The interconnection device of claim 1 wherein one or more interconnections include a parallel connection.

10. A power source comprising:
an interconnection device, the interconnection device comprising,
an insulating material;
a conductor coupled to the insulating material;
one or more batteries, each battery having one or more terminals;
wherein the interconnection device is coupled to the one or more batteries, and wherein the conductor is shaped in a pattern to facilitate one or more interconnections with the one or more batteries.

11. The power source of claim 10, wherein the insulating material further comprises a channel, wherein the conductor is disposed in the channel.

12. The power source of claim 11, wherein the insulating material includes an inlet and an outlet, the inlet and outlet coupled to the channel, wherein the inlet receives a coolant that flows through the channel and exits through the outlet, thereby cooling the conductor.

13. The power source of claim 10 wherein the conductor further comprises openings that correspond to the one or more terminals of the one or more batteries.

14. The power source of claim 13 wherein the power source further comprises one or more pins that are attached to the one or more terminals of the one or more batteries, and wherein the pins correspond to the openings of the conductor.

15. The power source of claim 10 further comprising a frame, wherein the one or more batteries and the interconnection device are configured to be mounted to the frame.

16. The power source of claim 15, wherein the interconnection device further includes a lock mechanism that secures the device to the frame.

17. The power source of claim 16, wherein the lock mechanism is a clamp.

18. The power source of claim 10, wherein the insulating material is laminated.

19. A method of manufacturing a power source having an interconnection device and one or more batteries each having one or more terminals, the method comprising:
Interconnecting the one or more terminals of the one or more batteries by a single-action assembly of the device onto the one or more terminals of the one or more batteries.

20. The method of claim 19 wherein the single-action assembly is by pressing the device onto the one or more terminals of the one or more batteries.
